(19) United States
(12) Patent Application Publication
(10) Pub. No.: US 2006/0209076 A1
(43) Pub. Date: Sep. 21, 2006

(54) Variable play back speed in video mail

(75) Inventor: Joon Maeng, Austin, TX (US)

Correspondence Address: Kelly K. Kordzik;Winstead Sechrest & Minick P.C., P.O. Box 50784, Dallas, TX, 75201, US

(73) Assignee: VTEL Corporation, Austin, TX (US)

(21) Appl. No.: 11/438,829

(22) Filed: May 23, 2006

Related U.S. Application Data
(63) Continuation of application No. 09/649,852, filed on Aug. 29, 2000, now abandoned.

(51) Int. Cl. G06T 15/70

(52) U.S. Cl. 345/473

(57) ABSTRACT

The present invention relates to the play back of previously recorded audio and video data. More particularly, the present invention relates to a computer system, method, and computer readable medium storing instructions executable by computer system for varying the playback rate of audio data as corresponding motion video data is displayed. In accordance with the present invention, the playback rate can be increased above or decreased below normal playback rates while maintaining the quality or tone of audio speech.

### BACKGROUND OF THE INVENTION

Electronic messaging is now commonplace in today's society. Electronic mail (e-mail), for example, is a ubiquitous and a common form of communication between users of computer systems or other devices linked together via a wired or wireless switched network data link such as the Internet or an intranet. E-mails typically include or attach type written text. Another example of current electronic messaging is video e-mail (v-mail). Typically, a v-mail includes or attaches a message including audio data and corresponding video data sent by a user. Often times, the audio data is a digital recording of the user's voice, and the video data relates to a series of images of the user as his voice is recorded. A computer system or other device receiving such a v-mail may play back the message attached or included therein by displaying a sequence of images and generating audio from the video and corresponding audio data, respectively. Typically, the images are displayed at 30 frames per second, and corresponding audio is generated at the same rate (e.g., a normal rate) at which the user's voice was originally recorded.

Video data, including those of v-mail messages, if not compressed, requires a large amount of data transfer bandwidth for its transmission between source and destination computer systems or other similar devices. Likewise, audio data, if not compressed, also requires a large amount of data transfer bandwidth. Various types of well known video and audio compression algorithms are used on video and audio data, respectively, to accommodate the limited transfer bandwidth between computer systems. In general, different video compression algorithms exist for still images and for moving images (a sequential display of images). Intraframe compression algorithms are used to compress data within a still image or single frame using spatial redundancies within the frame. Interframe compression algorithms are used to compress multiple frames, i.e., motion video, using the temporal redundancy between the frames. Interframe compression methods are used exclusively for motion video, either alone or in conjunction with intraframe compression methods.

### SUMMARY OF THE INVENTION

The present invention relates to the play back of previously recorded audio and video data. More particularly, the present invention relates to a computer system, method, and computer readable medium storing instructions executable by computer system for varying the playback rate of audio data as corresponding motion video data is displayed. In accordance with the present invention, the playback rate can be increased above or decreased below normal playback rates while maintaining the quality or tone of audio speech.

The present invention finds application with respect to audio data and corresponding video data received from a switched network such as the Internet. Additionally the present invention finds application with respect to digitally recorded audio data and corresponding video data of movie clips, v-mail, self-study tapes, etc. Often audio data and corresponding video data is received over the Internet in a compressed format. Before playback, the audio data and corresponding video data is decompressed. After decompression, first audio corresponding to a first portion of decompressed audio data is generated. The first audio is generated at a first audio generation rate. Thereafter second audio corresponding to the second portion of the decompressed audio data is generated. The second audio is generated at a second audio generation rate which differs from the first audio generation rate. However, the tone of second audio is substantially equal to the tone of the first audio. The first and second audio is generated as decompressed video data is displayed in image frames.

### BRIEF DESCRIPTION OF THE DRAWINGS

The present invention may be better understood, and its numbers objects, features and advantages made apparent to those skilled in the art by referencing the accompanying drawings. The use of the same reference number throughout the several figures designates a like or similar element.

FIG. 1 is a block diagram illustrating a networked computer system employing one embodiment of the present invention;

FIG. 2 is a block diagram illustrating one embodiment of a computer system of FIG. 1;

FIG. 3 is a block diagram illustrating the computer system shown in FIG. 1 in greater detail;

FIG. 4 shows a monitor displaying a graphical user interface for adjusting the rate of play back in accordance with one embodiment of the present invention;

FIG. 5 is a chart illustrating a relationship between audio generation rate and quality of sound;

FIG. 6a-6d illustrate exemplary adjustments to the display of decompressed frames of video data in accordance with adjustments to the play back rate of decompressed audio data;

FIG. 7 is a block diagram illustrating one embodiment of a circuit for adjusting the play back rate data.

### DETAILED DESCRIPTION

The present invention relates to adjusting the playback rate of digitally recorded audio data and corresponding video data of, for example, a v-mail message which has been transmitted via the Internet, an intranet or other wired or wireless data links (hereinafter referred to as a data link) between computer systems or similar devices. The present invention should not be limited to application to audio data and corresponding video data of a v-mail message. Rather, the present invention may find application to playback of any digitally recorded audio data and corresponding video data.

Typically, audio data and corresponding video data of a v-mail message is compressed before being transmitted to a destination computer system, or other similar device, via a datalink. The present invention will be described with respect to audio data and corresponding video data transmitted between source and destination computer systems, it being understood that the present may have application to data transmitted between other devices. Prior to transmission, the audio data and corresponding video data are typically compressed by the source computer system in accordance with any one of several well known audio and video compressing algorithms, respectively. The compressed audio data and corresponding video data, upon receipt by the destination computer system, are decompressed for subsequent play back by any one of several well-known data decompression techniques.

Audio data, after decompression, may be played back using transducers (i.e., speakers), while video data may be played back using an image display device (i.e., a monitor). The speaker generates audio (e.g., voice sounds) corresponding to the decompressed audio data while the image display device displays a sequence of image frames corresponding to the decompressed video data. The image display device generates full motion video by displaying image frames.

The present invention provides a computer system, a method, or a computer readable medium storing instructions executable by a computer system for increasing or decreasing the rate (measured with respect to normal rates) at which decompressed audio speech data is played back while corresponding video data is displayed.

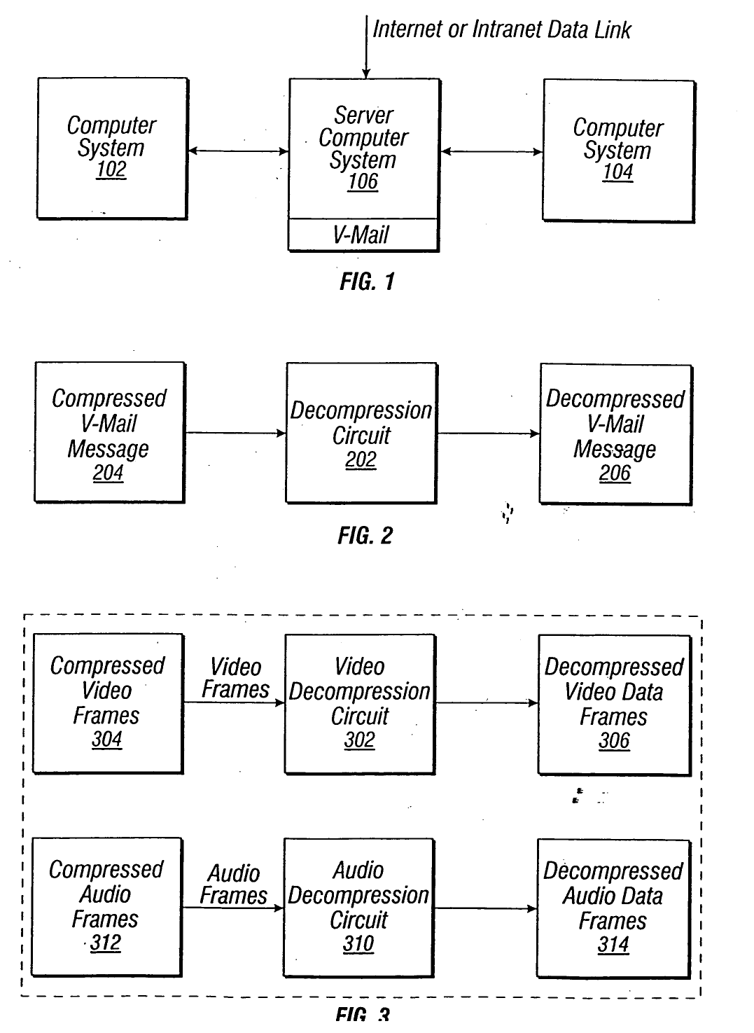

FIG. 1 is a block diagram of a system in which the present invention may find application. FIG. 1 illustrates a pair of computers 102 and 104 or other devices coupled to each other and to a server computer system 106, the combination of which is coupled to the Internet or an intranet data link. Server computer system 106 and computer systems 102 and 104 typically include at least one microprocessor and a memory medium. The memory medium may store data and instructions for processing data stored in the memory medium. The data stored in the memory medium may include compressed or decompressed audio data and corresponding video data of a v-mail message transmitted via the Internet or the intranet data link.

As used herein the term “microprocessor” generally describes the logic circuitry that responds to and processes basic instructions contained in a memory medium. The term “memory medium” includes an installation medium, e.g., a CD ROM, or floppy disks; a volatile computer system memory such as DRAM, SRAM, rambus RAM, etc.; or a non volatile memory such as optical storage or magnetic medium, e.g., a hard drive. The term “memory” is used interchangeably with “memory medium” herein. The memory may comprise other types of memory or combinations thereof. In addition, the memory may be located in a computer system in which the instructions are executed, or may be located in a second computer system (e.g., computer system 106 in FIG. 1) that connects to the first computer system over a network. In this later instance, the second system provides the instructions to the first computer for execution.

Computer systems may take various forms. In general, computer systems may include a digital signal processor or application specific integrated circuit for performing distinct functions. Alternatively, computer systems can be broadly defined to encompass any device having a microprocessor that executes instructions from a memory medium. Instructions for implementing the present invention on a computer system can be received by the computer system via a carrier medium. The carrier medium may include the memory media or storage media described above in addition to a communication medium such as a network and/or wireless link which carries instructions as signals such as electrical or electromagnetic signals.

Referring again to FIG. 1, compressed audio data and corresponding compressed video data may be received by computer system 102 from computer system 104 via server computer system 106, or from the Internet or the internet data link via server computer 106. The present invention should not be limited to computer system 102 receiving compressed audio and corresponding compressed video data via server computer system 106. Compressed data could be received by server computer system 106 and subsequently decompressed thereby. The audio and corresponding video data, once decompressed, may then be forwarded to computer system 102. Although not shown, computer system 102 could receive compressed audio data and corresponding video data directly from the Internet. The present invention, however, will be described with reference to computer 102 receiving compressed audio data and corresponding compressed video data from the Internet or the intranet directly or via server computer system 106.

In one embodiment the audio data and corresponding video data of a v-mail message received by computer system 102, is decompressed in accordance with one or more well know decompression algorithms. Computer system 102 may include peripherals (not shown in FIG. 1) for playing back the v-mail message after decompression. For example, computer system 102 may include a monitor for displaying a sequence of images corresponding to frames of the decompressed video data. Additionally, computer system 102 may include speakers for generating audio (i.e., voice reproduction) corresponding to decompressed audio data. The computer system is configured to generate the audio as the image frames are displayed.

The computer system 102 may include an input/output (I/O) device which enables a user to moderate the rate or speed at which the decompressed audio is generated by the speakers as the image frames are displayed. More particularly, the computer system 102 may include an input/output device which receives commands to increase or decrease the speed or rate at which decompressed audio data is played back. As will be more fully described below the increase or decrease in play back rate occurs with little or no loss of voice content thereof. While the audio is generated at an increased or decreased rate, the voice tone of the audio remains substantially the same as the voice tone of the same audio when played back at a normal rate. In other words, the audio is generated at an increased or decreased speed without sounding like a “chipmunk.” U.S. Pat. No. 5,873,059 entitled Method And Apparatus For Decoding And Changing The Pitch Of An Encoded Speech Signal, describes a technique for increasing or decreasing the play back rate of audio while maintaining tone and is incorporated herein by reference. Also, as will be more fully described below, increasing or decreasing the rate at which decompressed audio is played back may also alter the display of corresponding decompressed video data.

FIG. 2 represents one embodiment of computer system 102 shown in FIG. 1. More particularly, FIG. 2 shows a decompression circuit 202 coupled between a pair of memory mediums 204 and 206. In one embodiment, decompression circuit 202 includes a microprocessor executing instructions embodying one or more decompression algorithms. Memory medium 204 receives a v-mail message containing compressed audio data and compressed corresponding video data. In response thereto decompression circuit 202 decompresses the received data, the results of which are stored in memory medium 206. It is noted that two separate memories are not needed. Rather a single memory may receive both the compressed data and the results of the decompression.

FIG. 3 shows one embodiment of the computer system 102 shown in FIG. 2. More particularly, FIG. 3 shows a video decompression circuit 302 coupled between memory mediums 304 and 306 which store compressed and decompressed video data, respectively, of a v-mail message. FIG. 3 also illustrates an audio decompression circuit 310 coupled between a pair of memory mediums 312 and 314 which for storing compressed and decompressed audio data, respectively, of a v-mail message. In one embodiment the audio and video decompression circuits may be embodied in a single microprocessor executing separate decompression algorithms. Video decompression circuit 302 reads and decompresses the corresponding compressed video data received by memory medium 304. In one embodiment video decompression circuit 302 reads and decompresses frames of corresponding video data from memory medium 304, wherein each frame of video data corresponds to an image to be displayed on the monitor (not shown in FIG. 2). Data decompressed by video decompression circuit 302 may be stored in memory medium 306 for subsequent display upon the monitor as will be more fully described below. Audio decompression circuit 310 reads and decompresses audio data received by memory medium 312. Data decompressed by audio decompression circuit 310 may be stored in memory medium 314 for subsequent play back using a speaker coupled thereto. Video decompression circuit 302 and audio decompression circuit 310 may decompress video data and audio data, respectively, in synchronism. Alternatively, video decompression circuit 302 may decompress all or a portion of video data received by memory medium 304 before audio decompression circuit 310 decompresses all or a portion of corresponding audio data received by memory medium 312.

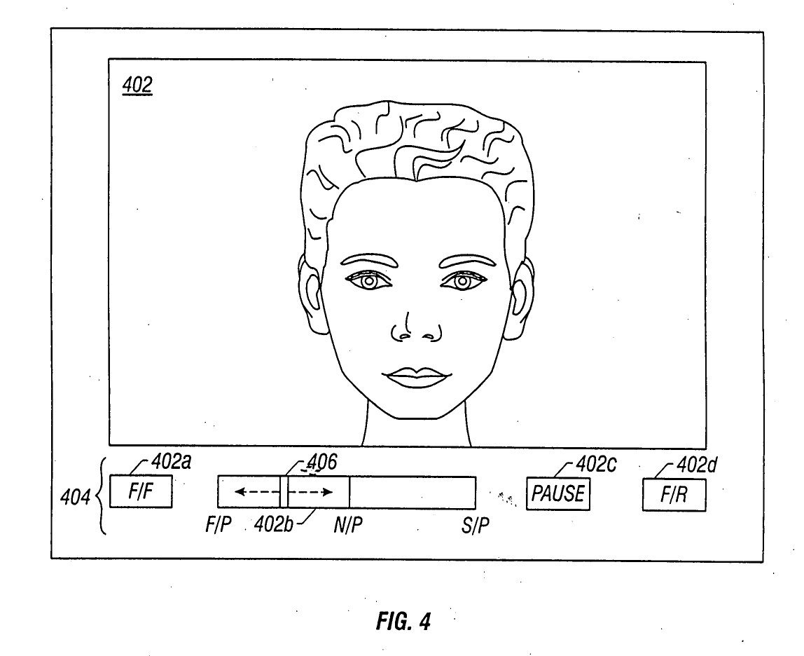

With continuing reference to FIG. 3, FIG. 4 illustrates a monitor of computer system 102 having a display area 402 for displaying image frames of video data stored in memory 306, and a graphical user interface 404 embodying the input/output device, as described above, for receiving commands to increase or decrease playback speed of decompressed audio data and corresponding video data. The graphical user interface 404 may include at least four fields or electronic buttons for controlling the rate of audio and corresponding video play back. More particularly, graphical user interface 404 may include a fast forward (F/F) field 402a for fast forwarding through data of memories 306 and 314 at a set rate when initiated. In one embodiment, audio, during fast forward, is not generated by the speaker of computer system 102. Rather, data of memory 314 is skipped without audio generation until fast forwarding has terminated. In another embodiment, audio is generated from data of memory 314 at a faster rate without any concern for maintaining tone or pitch. In this embodiment, such generated audio cannot be comprehended by a user. Rather, the generated audio will sound like high pitched “chipmunk” sounds. In either embodiment, data from memory 314 corresponding to audio data skipped or played back without regard to tone, may be sequentially displayed in frames at an increased speed.

The graphical user interface 404 may include a playback rate adjustment field or bar 402b for adjusting the rate at which decompressed audio data and corresponding video data are played back. N/P designates normal playback rate, F/P designates fast playback, and S/P designates slow playback. Even though the playback rate of audio is increased or decreased using field 402b, the tone or pitch of the resulting audio is substantially similar to that of audio generated at normal rates (e.g., the rate at which the audio was originally recorded). In one embodiment, the play back of the audio speech data above or below the normal rate, employs techniques described in U.S. Pat. No. 5,873,059. Thus, an increased or decreased rate of audio generation (when compared with normal speed) will be comprehendible by the user. As will be more fully described below, the display of the image frames will be adjusted to account for the increase or decrease rate of the audio generation.

The graphical user interface 404 may further include field 402c which may be used to pause the play back of decompressed audio data stored in memory 314 and corresponding image frames of data from memory 306. Lastly, the graphical user interface 404 may include a field 402d which may be used to fast reverse through data stored in memories 306 and 314 in much the same way as the fast forward field enables fast forwarding through the data described above.

Functions associated with fields or electronic buttons or electronic bars 402a-402d may be initiated by pointing to and clicking, for example, buttons or bars 402a, c, and 402d with a cursor controlled by a mouse. The function associated with button 402b can be implemented by moving bar 406 left or right using a cursor controlled by a mouse. In another embodiment, the graphically user interface may include fields for receiving numeric data. More particularly, the graphical user interface may include a field for receiving numerical data representing the rate at which decompressed audio and corresponding video data are played back.

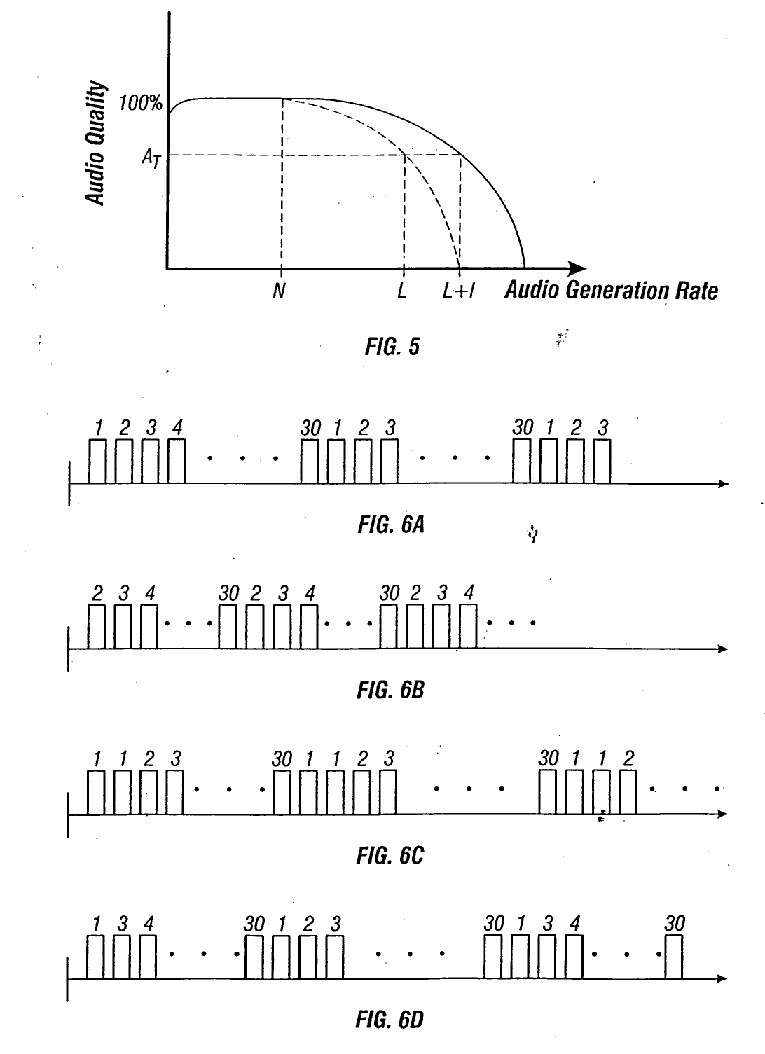

While decompressed audio can be played back at an increased speed while maintaining tone or pitch, the increase has a limit. FIG. 5 is a graph comparing audio quality versus the rate at which audio is generated. At normal generation rate N, audio speech comprehension is typically 100%. In other words, when audio speech is generated at normal rate N there is no decrease in listener comprehension.

However, when the audio generation rate increases to L with a corresponding change in tone or pitch (i.e., there is simply an speed increase at which audio is generated with no further processing of audio data to accommodate the change in the resulting pitch), the audio quality falls below a threshold A_{T} at which audio comprehension may become compromised. However, where the audio data is processed in accordance with the techniques described in U.S. Pat. No. 5,873,059 prior to audio generation, the rate limit where the audio degrades to incomphrensionable sounds, extends to L+1.

Typically, image frames of data stored in memory 306, are displayed on the monitor in sync with corresponding audio data in memory 314 when play back occurs at normal rate. Normally, the image frames are displayed at a frequency of 30 frames per second. At normal playback rate, each 30 image frames is displayed as a corresponding amount of audio data is played back. Thus, a second's worth of audio data is played back with each corresponding 30 image frame set when play back occurs at normal speed. FIG. 6a illustrates a time sequence of frame display at normal speed. With reference to FIG. 6a, a set of 30 distinct frames (only frames 1-4 and 30 are illustrated) of video data are displayed each second.

As noted above, the playback speed of audio data may be increased or decreased in accordance with the present invention. To insure an illusion of video continuity, the display of the image frames is adjusted in accordance with the change in speed of the audio generation rate. For example, if the audio play back rate increases, then it may be desirable to omit displaying one or more frames of each 30 image frame set (or every other 30 frame set) corresponding with the audio data played back. In this fashion, the 30 frames per second display rate is maintained. FIG. 6b illustrates a display rate adjusted to correspond to an increased audio playback rate whereby the first frame of each 30 frames is omitted from display. FIG. 6B corresponds to a 3.33% increase in playback speed. Alternatively, a pair of sequential image frames in each 30 frame set (or every other 30 frame set if an less than 3.33% is sought) may be interpolated into one image frame which is subsequently displayed in favor of the sequential pair.

As noted above, audio playback may be slowed below normal. FIG. 6c illustrates adjustments to the frame display rate in accordance with a decreased playback rate. More particularly, in FIG. 6c, at least one frame in each 30 frame set (or every other 30 frame set) is displayed twice in succession as the corresponding audio data is played back at a lower rate. Again the overall video frame rate is maintained at 30 frames per second. FIG. 6d illustrates a display rate modified by omitting one frame from every other group of thirty frames. This corresponds to a 3.33% decrease in playback rate from normal. The display rate shown in FIG. 6d corresponds to an playback rate slower than that associated with FIG. 6c. In FIG. 6d, one frame of every other 30 frame image set is discarded as audio is generated. This corresponds to a 1.67% decrease of playback rate from normal. Again, to maintain an illusion of continuity, the display rate of video at 30 frames per second should be maintained when a decreased playback speed is employed. By omitting, interpolating, or duplicating frames in accordance with that shown in FIGS. 6b through 6d, display of the image frames substantially coincide in time with the generation of audio notwithstanding the increased or decreased playback rate. It is noted that an increased audio generation rate is defined as a rate higher than N shown in FIG. 4. Moreover, a decreased audio generation rate is less than N.

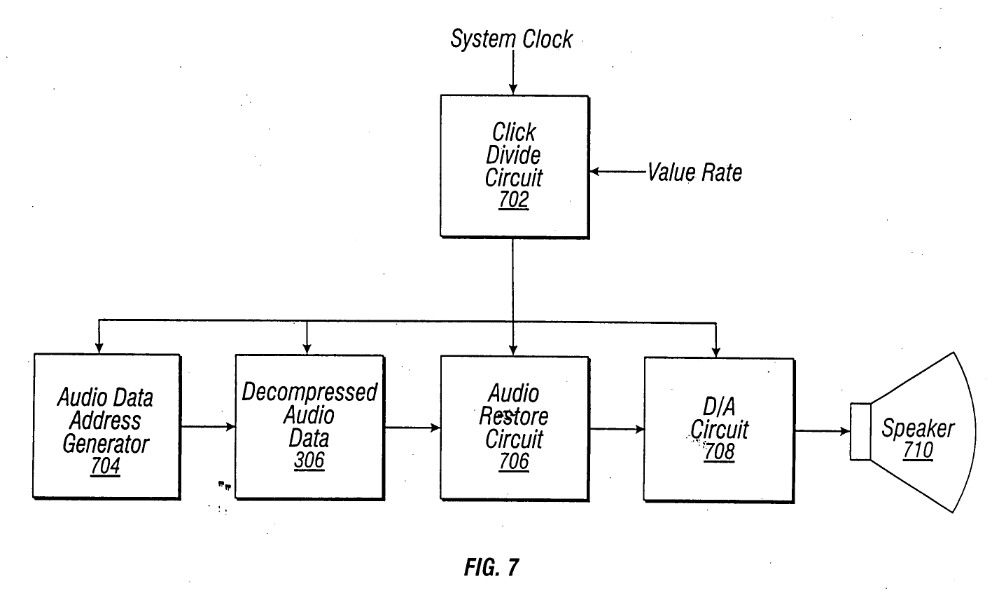

FIG. 7 illustrates one embodiment of a system for rendering decompressed audio data. FIG. 7 includes a clock divider circuit 702, an audio data address generator 704, decompressed audio data memory medium 306, an audio restore circuit 706, an digital to analog converter circuit 708, and speaker 710. Clock divide circuit 702 receives a system clock and a play back rate value. The system clock is typically invariable. The play back rate value may be derived or received directly or indirectly from input to the graphical user interface shown in FIG. 4. For example, the playback rate value may be derived from the position of the moving bar 406 in field 402b. Clock device circuit 602 outputs a clock which has a frequency corresponding to the play back rate value inputted into clock divide circuit 702. This is typically lower than the frequency of the system clock input. The output of clock divide circuit 702 is provided to audio data address generator 704. Audio data address generator 704 sequentially generates addresses of memory 306 which contain decompressed audio data. The rate at which audio data address generator generates addresses depends upon the clock frequency input thereto. With each audio data address generated by audio data address generator 704, decompressed audio data memory 306 outputs corresponding decompressed audio data stored therein. This data is subsequently provided to audio restore circuit 706. Audio restore circuit processes received audio data in accordance with an increased or decreased clock frequency input to maintain the same tone or pitch the resulting audio would exhibit if it were played back at a normal rate. Audio data, once restored, is provided to digital to analog converter 708 where is converted into analog form and output to an input of speaker 710. Speaker 710, intern, generates corresponding audio.

With an increase or decrease in the play back rate value, the output of clock divide circuit 702 increases or decreases in frequency thereby increasing or decreasing the rate at which audio data address generator 704 generates sequential memory addresses. Additionally, the increased or decreased clock frequency signals audio restore circuit to process received audio data in a manner which maintains tone so that the resulting generated audio is comprehendible.

Although the present invention has been described in connection with several embodiments, the invention is not intended to be limited to the specific forms set forth herein, but on the contrary, it is intended to cover such alternatives, modifications, and equipment's as can be reasonably included within the spirit and scope of the invention as defined by the appending claim.

What is claimed is:

1. A method comprising:
reading first audio data stored in memory;
generating first audio corresponding to the first audio data, wherein the first audio is generated at a first audio generation rate;
sequentially displaying first image frames on a monitor as the first audio is generated, wherein the first image frames correspond to the first audio data;
reading second audio stored in memory;
generating second audio corresponding to the second audio data, wherein the second audio is generated at a second audio generation rate;
sequentially displaying second image frames on a monitor as the second audio is generated, wherein the second image frames correspond to the second audio data;
wherein the second audio is generated after the first audio is generated;
wherein the second audio generation rate is distinct from the first audio generation rate; and
wherein the first audio is generated at a tone substantially equal to that of the second audio.

2. The method of claim 1 wherein the first and second image frames are displayed at equal rates.

3. The method of claim 1 wherein the first and second audio data are substantially equal in quantity, wherein the first audio is generated within a first time period, wherein the second audio is generated in a second time period, and wherein the first time period is greater or lesser than the second time period.

4. The method of claim 1 wherein at least two image frames of the sequentially displayed second image frames, are identical.

5. The method of claim 1 wherein at least one frame of the sequentially displayed second frames represents an interpolation of first and second video data, wherein the first and second video data correspond to distinct image frames.

6. The method of claim 1 further comprising:
inputting the first audio generation rate via a graphical user interface;
generating the first audio at the first audio generation rate in response to inputting the audio generation rate in third memory;
inputting the second audio generation rate via the graphical user interface;
generating the second audio at the second audio generation rate in response to inputting the second audio generation rate in memory.

7. The method of claim 1 further comprising:
displaying a graphical user interface on a monitor, wherein the graphical user interface comprises a first field configured to receive data;
entering data relating the first audio generation rate into the first field of the graphical user interface;
entering data relating to the second audio generation rate into the first field of the graphical user interface.

8. The method of claim 1 further comprising receiving a message via the Internet, wherein the message comprises first and second compressed audio data, wherein the first and second audio data results from decompressing the first and second compressed audio data, respectively.

9. A carrier medium comprising instructions executable by a computer system to implement a method, the method comprising:
reading first audio data stored in memory;
generating first audio corresponding to the first audio data, wherein the first audio is generated at a first audio generation rate;
sequentially displaying first image frames on a monitor as the first audio is generated, wherein the first image frames correspond to the first audio data;
reading second audio stored in memory;
generating second audio corresponding to the second audio data, wherein the second audio is generated at a second audio generation rate;
sequentially displaying second image frames on a monitor as the second audio is generated, wherein the second image frames correspond to the second audio data;
wherein the second audio is generated after the first audio is generated;
wherein the second audio generation rate is distinct from the first audio generation rate; and
wherein the first audio is generated at a tone substantially equal to that of the second audio.

10. The carrier medium of claim 9 wherein the first and second image frames are displayed at equal rates.

11. The carrier medium of claim 10 wherein the first and second audio data are substantially equal in quantity, wherein the first audio is generated within a first time period, wherein the second audio is generated in a second time period, and wherein the first time period is greater or lesser than the second time period.

12. The carrier medium of claim 10 wherein at least two image frames of the sequentially displayed second image frames, are identical.

13. The carrier medium of claim 10 wherein at least one frame of the sequentially displayed second frames represents an interpolation of first and second video data, wherein the first and second video data correspond to distinct image frames.

14. A computer system comprising:
a microprocessor for decompressing first data received by the computer system from a switched network;
a first memory coupled to the microprocessor and configured to store first data decompressed by the microprocessor;
a third memory configured to store an audio generation rate;
a graphical user interface coupled to the third memory, wherein the graphical user interface is configured to receive data corresponding to the audio generation rate;
an audio transducer coupled to the third memory and configured to generate audio corresponding to decompressed first data stored in the first memory, wherein the audio transducer generates audio at a rate according to the audio generation rate stored in the third memory;
wherein audio corresponding to decompressed first data is generated by the audio transducer at a constant tone for more than one audio generation rate stored in the third memory.
